(19) United States
(12) Patent Application Publication
(10) Pub. No.: US 2019/0141986 A1
(43) Pub. Date: May 16, 2019

(54) VESSEL FOR VITRIFICATION-CRYOPRESERVATION IN LIQUID, KIT PROVIDED WITH VESSEL AND TUBE FOR RECEIVING SAME, AND METHOD FOR VITRIFICATION-CRYOPRESERVATION IN LIQUID

(71) Applicant: INUI MEDICAL LIMITED, Koriyama-shi, Fukushima (JP)

(72) Inventors: Hiroaki INUI, Koriyama (JP); Jinji MIZUNO, Koriyama (JP)

(73) Assignee: INUI MEDICAL LIMITED, Koriyama-shi, Fukushima (JP)

(21) Appl. No.: 16/097,144

(22) PCT Filed: Apr. 27, 2016
(86) PCT No.: PCT/JP2016/063147

§ 371 Date: Jan. 4, 2019

(51) Int. Cl. A01N 1/02; B01L 3/00

(52) U.S. Cl. CPC A01N 1/0221; B01L 7/50; B01L 3/50; A01N 1/0284

(57) ABSTRACT

A vessel is provided for cryopreservation by vitrification for use in the cryopreservation by vitrification of cells or embryos. The cells or embryos are retained by a retaining part of the vessel and has recesses on the retaining part to store the cells or embryos therein. The vessel for cryopreservation by vitrification in a liquid cryogen has holes in the walls which make up the recesses which do not allow the cells or embryos to pass through the walls, but which do allow vitrification solution to pass therethrough. A kit is also provided which includes the vessel and a tube for storing the vessel. A method for cryopreservation by vitrification in a liquid cryogen is also provided.

### CROSS-REFERENCE TO RELATED APPLICATIONS

This patent specification claims the benefit of the contents of the patents, patent applications, and references cited in this patent application.

This application is a U.S. National Stage application of International Application No. PCT/JP2016/063147 filed on Apr. 27, 2016 and published in Japanese as WO 2017/187543 on Nov. 2, 2017. The entire disclosure of the above application is incorporated by reference herein.

### BACKGROUND

### Technical Field

The present invention comprises a vessel for the cryopreservation by vitrification in a liquid cryogen of biological materials such as cells or embryos, a kit comprising said vessel and a tube to store it in, and methods for cryopreservation by vitrification in a liquid cryogen.

### Related Art

Cells and embryos (henceforth generically referred to as “cells etc.” where appropriate) have been preserved for long periods of time under conditions that do not damage their cellular characteristics in the past. For example, there are known methods for the cryopreservation of mammalian embryos, and subsequent thawing and implantation of said embryos in said mammals during their estrus cycle. Additionally, one kind of infertility treatment in humans involves cryopreserving an egg, or an embryo at one of many developmental stages (immature egg, mature unfertilized egg, pronuclear embryo, early embryo, blastocyst, blastocyst with a removed zona pellucida, etc.), and then said frozen egg or embryo is thawed and used when the woman would like to get pregnant.

Slow freezing is a popular cryopreservation method for mammalian early embryos. Slow freezing involves placing an embryo in a solution which includes dimethyl sulfoxide (DMSO) and glycerol to reach certain concentrations, and then slowly cooling the solution to freeze it. Slow freezing is suitable for mammalian embryos, including human embryos, but an issue with this method of cryopreservation is that it has a low survival rate for unfertilized eggs and some particular embryos. The main cause for this is thought to be damage caused by the crystallization of the water inside and outside of the unfertilized egg or embryo. A new cryopreservation technique called vitrification was developed in order to solve this issue (see Rall, W. F. et al., Nature, 313, 573-575 (1985)). Vitrification generally involves the following steps. First, a vitrification solution is prepared, which is done by creating a mixture of culture medium and low molecular weight cryoprotectants which penetrate into the cell such as DMSO, ethylene glycol, propylene glycol, and glycerol, as well as a high concentration of high molecular weight disaccharides which do not penetrate into the cell and exhibit a cryprotective effect due to the removal of free water in the extracellular fluid, such as sucrose and trehalose. Next, the cells etc. are suspended or immersed in the vitrification solution, which replaces the water inside and outside of the cells etc. with vitrification solution. Next, the cells etc. are kept in a cryopreservation vessel. Lastly, the cryopreservation vessel that the cells etc. are held in is submerged in liquid nitrogen, cryopreserving them. Quick freezing in liquid nitrogen and the use of a high concentration of cryoprotectants contribute to a decrease in crystallization, which is a source of damage to cells etc.

Different vitrification methods are known, such as the VSED method, gel-loading tip method, and Cryotop method. In the VSED method, a straw is used for the preservation vessel of the cells etc. wherein the internal part of the straw is filled with vitrification solution; the cells etc. in the straw are then cryopreserved (Japanese Unexamined Patent Application Publication No. 1998-248860). In the gel-loading tip method, a gel-loading tip is used as the preservation vessel of the cells etc.; the vitrification solution is drawn up alongside the cells etc. into the tip using a pipette or the like, and then it is frozen. In the Cryotop method, the vitrification solution and the cells etc. are placed on the edge of a liquid nitrogen-resistant sheet called a Cryotop (registered trademark), and then the Cryotop is immersed as-is in liquid nitrogen to freeze the cells etc. (Japanese Unexamined Patent Application Publication No. 2002-315573). Out of these methods, only the Cryotop method is at the stage of practical application.

FIGS. 14A and B show the typical procedure for the cryopreservation of cells via the Cryotop method using eggs as an example. FIG. 14A is a global image of the operation, and FIG. 14B shows the steps that take place at the location indicated by an X in FIG. 14A. As shown in FIG. 14A, multiple eggs 102 are immersed in the vitrification solution 101 in the culture plate 100. Next, vitrification solution 101 containing an egg 102 is sucked up from the culture plate 100 using the tip of a small glass pipette 110. Next, as shown in FIG. 14B, the egg 102 and vitrification solution 101 in the pipette 110 are expelled onto the tip of the sheet 121 on the “Cryotop” cryopreservation vessel 120. If there is too much vitrification solution 101 after that, the excess vitrification solution 101 is sucked up into the pipette 110. Afterwards, the cryogenic preservation vessel 120 with the eggs 102 on it is placed into liquid nitrogen, which rapidly freezes the eggs. The excess vitrification solution 101 is sucked up because if there is too much vitrification solution 101 around the eggs 102, it will decrease the cooling speed, and the survival rate of the eggs 102 will decrease. However, sucking up a suitable amount of the vitrification solution 101 on the sheet 121 is an operation that requires skill; the fact that eggs 102 will be damaged if they are dried out is also an issue.

An example of a jig that solves this issue and makes these cryopreservation operations easier is a jig for cryopreservation by vitrification which has an absorbent layer that is able to absorb excess vitrification solution (patent reference 3). When using this jig, even if too much vitrification solution is expelled onto the jig's sheet, there is no need to suck up vitrification solution with a pipette. In addition, the jig for cryopreservation by vitrification that is holding the eggs or the like can be put into liquid nitrogen quickly without damaging the eggs or the like.

Also, another jig is known, which has been developed by the authors of the present invention (patent reference 4). FIGS. 15A-C show the usage procedure for the cryopreservation vessel previously developed by the authors of this invention. FIG. 15A shows a global image of the procedure. FIG. 15B is an enlarged view of the location in FIG. 15A marked by the X. FIG. 15C shows a cross-sectional diagram along the Y-Y plane marked in FIG. 15B. The said cryopreservation vessel 130 is equipped with multiple holes 140 that have a volume of 50 nl or less. When using this vessel 130, the surface tension of the vitrification solution 101 supplied by the pipette 110 can maintain a consistent volume of vitrification solution 101 around the eggs 102 that are in the holes 140. Due to this, the size of the holes 140 is decided beforehand (diameter: Z) so that a consistent volume of vitrification solution 101 can be retained on the sheet 131 no matter who is carrying out the operation. Consequently, it is not necessary to adjust the amount of vitrification solution 101 before freezing.

However, additional improvements are needed to further increase the survival rate of cells etc. As detailed above, all conventional cryopreservation operations are conducted in open air on a thin sheet or a sheet with holes integrated into it; an extremely small volume of vitrification solution containing the cells etc. is used. Due to this, if the cells etc. are in contact with air for a long period of time during the process between being immersed in the vitrification solution and rapid freezing, they could dry out. Also, they may be exposed to large changes in pH, temperature, and/or osmotic pressure. Such large changes in pH etc. are a major factor in causing damage to the cells etc. Also, while the cells etc. are being retained on a sheet or after they have been retained on a sheet in conventional methods, there is a possibility that they may fall off of the sheet. If any of the cells etc. happen to be an egg or embryo, the person from whom it was retrieved may be subjected to physical or psychological stress from repeated egg retrieval. The chances of cells etc. falling increases if the technicians who are conducting the cryopreservation process are unskilled.

Additionally, the need for reducing damage to cells etc. and reducing the need to re-performing operations due to failure are not limited to infertility treatment; it is also extremely important when handling cells etc. for the breeding and conservation of mammalian genetic resources or when handling embryonic stem (ES) cells or induced pluripotent stem (iPS) cells, which are important to regenerative medicine.

The current invention was developed to solve the issues described above; the aim of it is to provide a vessel for cryopreservation by vitrification in a liquid cryogen that can decrease damage to cells or embryos, and increase work efficiency, a kit comprising said vessel and a tube to hold its contents, as well as a method of cryopreservation by vitrification in a liquid cryogen.

### SUMMARY

As a result of diligent efforts, the authors of the present invention discovered that preventing cells etc. from contacting air immediately before freezing can protect the cells etc. from drying as much as possible, and can protect against large changes in pH, temperature, and/or osmotic pressure to further decrease damage to cells etc. and further increase the operational efficiency of the process of cryopreservation by vitrification. The authors of this invention achieved this goal by the following methods.

(1) One embodiment of the vessel for cryopreservation by vitrification in a liquid cryogen is a vessel for cryopreservation by vitrification in which the cells or embryos (hereafter, cells etc.) are retained for cryopreservation by vitrification; the said vessel comprises a retaining part which retains the cells or embryos, recesses in said retaining part to put cells or embryos in, and holes in the walls making up said recesses that allow vitrification solution to pass through them without allowing cells or embryos to pass through.

(2) In another embodiment of the vessel for cryopreservation by vitrification in a liquid cryogen, said recesses are open on one face of the said retaining part, and they protrude outwards from the opposite face.

(3) In another embodiment of the vessel for cryopreservation by vitrification in a liquid cryogen, there is a cross-shaped band in said base of said recesses, and said holes comprise the gap between said base and said cross-shaped band.

(4) In another embodiment of the vessel for cryopreservation by vitrification in a liquid cryogen, the inner volume of said recesses with said holes blocked is maximum 30 nl.

(5) In another embodiment of the vessel for cryopreservation by vitrification in a liquid cryogen, a shock-mitigating part to dampen shocks is added to said retaining part closer to the tip part of said retaining part than said recesses.

(6) In another embodiment of the vessel for cryopreservation by vitrification in a liquid cryogen, there is a grip on one end.

(7) In another embodiment of the vessel for cryopreservation by vitrification in a liquid cryogen there are lids over the openings of said recesses which can be opened and closed.

(8) One embodiment of the kit includes at least one embodiment of the vessel for cryopreservation by vitrification in a liquid cryogen described above, and a tube that can store at the least the retaining part of said vessel for cryopreservation by vitrification in a liquid cryogen which retains the cells or embryos.

(9) In another embodiment of the kit, the sealed inside of said tube has undergone sterilization treatment before use; one side is opened when said vessel for cryopreservation by vitrification in a liquid cryogen is loaded with cells or embryos on said retaining part, then the end of said vessel for cryopreservation by vitrification in a liquid cryogen which has said retaining part is inserted into said tube so that it passes over said retaining part to a prescribed position to create a seal.

(10) In another embodiment of the kit, said vessel for cryopreservation by vitrification in a liquid cryogen has a retaining part at one end, and said vessel for cryopreservation by vitrification in a liquid cryogen is inserted into said tube which may be sealable at said prescribed location along the length of said retaining part.

(11) In another embodiment of the kit, said vessel for cryopreservation by vitrification in a liquid cryogen has a diameter expansion component with a diameter that expands to a larger diameter than said retaining part, and said vessel for cryopreservation by vitrification in a liquid cryogen is inserted into said tube which may be sealable at said prescribed location on said diameter expansions component.

(12) In another embodiment of the kit, the location where said tube is opened during use may be displayed on said tube.

(13) One embodiment of a vitrification method for cells or embryos involves putting cells or embryos into recesses within vitrification solution on one of the previously described vessels for cryopreservation by vitrification in a liquid cryogen.

(14) In another embodiment of a vitrification method for cells or embryos, one of the previously described vessels for cryopreservation by vitrification in a liquid cryogen is inserted into said vitrification solution which contains cells or embryos, and cells or embryos may be put into the recesses on said vessel for cryopreservation by vitrification wherein said vessel is immersed in said vitrification solution.

(15) In another embodiment of a vitrification method for cells or embryos, said vessel for cryopreservation by vitrification in a liquid cryogen with said recesses retaining cells or embryos may be removed from the vitrification solution, and either directly immersed in a cryogen, or inserted into a tube which has one end immersed in a cryogen.

(16) In another embodiment of a vitrification method for cells or embryos, after removing said vessel for cryopreservation by vitrification in a liquid cryogen retaining cells or embryos in said recesses from said vitrification solution said vessel may either directly immersed in a cryogen, or inserted into a tube which has one end immersed in a cryogen within 1-90 seconds.

(17) In another embodiment of a vitrification method for cells or embryos, a well plate with at least three wells that have the same depth at bottom surface as the internal volume of an open well plate, or a height that is shallower than said depth is used; equilibrium solution is put into one or more first wells, vitrification solution is put into one or more second wells, and vitrification solution is put into one or more third wells. The recesses on a vessel for cryopreservation by vitrification in a liquid cryogen are immersed in vitrification solution in advance. Then cells or embryos are transferred from the first well to the second well to the third well in order. Then said vessel for cryopreservation by vitrification in a liquid cryogen containing said cells or embryos in its recesses is removed from the vitrification solution in the third well. Then, said vessel for cryopreservation by vitrification in a liquid cryogen containing cells or eggs in its recesses may be immersed in a cryogen.

In this application “cryopreservation by vitrification,” and “vitrification” refer to the freezing of the water in a cell or in the inner cell mass of an embryo (which may also include the outer membranes) into a non-crystalline amorphous solid by reducing crystallization in said water.

In this application, a “vitrification solution” comprises a solution containing antifreeze agents (also called cryoprotective agents), preferably one made by the procedure below. First, a culture medium is prepared which contains: sodium chloride, potassium dihydrogenphosphate, potassium chloride, calcium chloride, magnesium sulfate heptahydrate, 19 kinds of amino acids, sodium bicarbonate, ethylenediaminetetraacetic acid (EDTA) disodium dihydrate, gentamicin sulfate, polyvinyl alcohol, L-alanyl-L-glutamine, and HEPES (4-(2-hydroxyethyl)-1-piperazineethanesulfonic acid)-containing culture medium which also contains D-glucose, lactates such as sodium DL-lactate, and pyruvates such as sodium pyruvate as energy sources. Next, ethylene glycol and dimethyl sulfoxide (DMSO) are added to said basic culture medium to achieve a final concentration of 15% each, to create a vitrification solution with a 30% concentration of antifreeze agents. Similarly, the vitrification solution may be made by adding the ethylene glycol and DMSO so that they both achieve final concentrations of either 7.5%, 6%, 4.5%, or 3%, yielding a vitrification solution with either a 15%, 12%, 9%, or 6% concentration of antifreeze agents. Furthermore, sucrose, polyvinyl alcohol, Ficoll, and hyaluronan may be added to any of the aforementioned vitrification solutions to achieve final concentrations of 0.5M, 0.1%, or 1%, to yield a vitrification solution (with an antifreeze agent concentration of 30%, 15%, 12%, 9% or 6%). One or more other antifreeze agents aside from DMSO and ethylene glycol, such as glycerol, propylene glycol, butanediol, and polylysine, may also be used. Examples of polylysine include ε-poly-L-lysine, ε-poly-D-lysine, α-poly-L-lysine, and α-poly-D-lysine. A polylysine with at least one of the hydrogen atoms bound to the amino group in polylysine is replaced with a carboxyl group, for example carboxylated poly-L-lysine (COOH-PLL), may also be used. The vitrification solution may also include one or more of sucrose, glucose, trehalose, dextran, Percoll, polyethylene glycol, polyvinyl alcohol, hyaluronan, fibronectin, polyvinyl pyrrolidone, bovine serum albumin, and serum Ficoll in addition to the aforementioned antifreeze agents. The mass percentage of antifreeze agents as part of the whole vitrification solution including antifreeze agents is preferably 1%-40%, more preferably 2%-20%, and still more preferably 3%-9%.

In this application, there are no limitations to cell type as long as the cells that are to undergo cryopreservation are able to be cryopreserved by vitrification, but they are preferably eukaryotic cells, and more preferably animal cells such as mammalian or insect cells or plant cells, and still more preferably mammalian cells. Also, it is ideally possible to collect the cells or embryos from, for example: humans; livestock such as cows, pigs, goats, sheep, etc.; laboratory animals (mice, rats, rabbits, etc.); or wild animals. Examples of cells include undifferentiated cells such as sperm cells, oocytes, amniotic mesenchymal stem cells, unfertilized egg cells, fertilized eggs cells, embryonic cells, embryonic stem (ES) cells, hematopoietic stem cells, mesenchymal stem cells, neural stem cells, cancer stem cells, or induced pluripotent stem (iPS) cells; as well as endothelial cells such as endometrial cells, oviductal epithelial cells, amniotic epithelial cells, epithelial cells such as cholangiocytes, fibroblasts, sinusoidal endothelial cells, endothelial cells such as vascular endothelial cells, differentiated cells such as hepatocytes. The cells are preferably undifferentiated cells, more preferably undifferentiated reproductive cells such as sperm cells, oocytes, amniotic mesenchymal stem cells, unfertilized egg cells, fertilized eggs cells, embryonic cells, or embryonic stem (ES) cells. Additionally, in this application examples of embryos to be cryopreserved include pronuclear embryos, early embryos, and blastocysts.

The cryogens (also referred to as refrigerants) used in this application are not limited so long as the cells or embryos can be frozen in a vitrified state, but they will preferably be materials with a high degree of safety. The cryogen may be, for example, liquid nitrogen, slush nitrogen, liquid helium, liquid propane, or ethane slush, but preferably liquid nitrogen or slush nitrogen. Slush nitrogen refers to liquid nitrogen that is maintained under reduced pressure to lower the temperature to between −205° C. and −210° C., which is past the temperature of liquid nitrogen at standard pressure (−196° C.) (Huang et al., Human Reproduction, Vol. 20, No. 1, pp. 122-128 (2005)). For example, when using slush nitrogen as a cryogen, equipment such as the Vit-Master™ (IMT. Nes Ziona, Israel) can be used to conduct cryopreservation by vitrification.

### Advantageous Effects of the Invention

Damage to cells etc. can be reduced, and operational efficiency can be increased by this invention.

### BRIEF DESCRIPTION OF THE DRAWINGS

FIG. 1A shows the top view, FIG. 1B shows the side view, and FIG. 1C shows the perspective view of the first embodiment of the present invention, a vessel for cryopreservation by vitrification in a liquid cryogen.

FIG. 2A shows an enlarged view of area A in FIG. 1C, and FIG. 2B shows A′, which is an enlarged view of the reverse side of area A.

FIG. 3A shows the recesses shown in FIG. 2A with fertilized eggs in them, and

FIG. 3B shows a cross section along the C-C plane of said two recesses holding fertilized eggs as in FIG. 3A.

FIG. 4 shows an enlarged view of part B shown in FIG. 1C.

FIG. 5 shows a perspective view of the kit including a vessel for cryopreservation by vitrification and a tube that houses the thin sheet of said vessel.

FIG. 6 shows a schematic outline to explain an embodiment of the method for cryopreservation by vitrification of fertilized eggs using a vessel for cryopreservation by vitrification (method for cryopreservation by vitrification in a liquid cryogen)

FIG. 7A shows the top view, FIG. 7B shows the side view, and FIG. 7C shows the perspective view of the second embodiment of the present invention, a vessel for cryopreservation by vitrification, and FIG. 7D shows an enlarged view of area H in FIG. 7C.

FIG. 8A shows a perspective view of a kit including the vessel for cryopreservation by vitrification shown in FIGS. 7A-7C, and FIG. 8B shows a tube to store the thin sheet part of said vessel.

FIG. 9A shows the area around the recesses in the third embodiment of the vessel for cryopreservation by vitrification as an enlarged perspective view of the bottom of said recesses and FIG. 9B shows a cross-sectional view of said recesses similar to that in FIG. 3B.

FIG. 10A shows the area around the recesses in the fourth embodiment of the vessel for cryopreservation by vitrification, including an enlarged perspective view of the side of said recesses with the apertures, FIG. 10B shows an enlarged perspective view of the underside of said recesses, and FIG. 10C shows a cross-sectional view of said recesses similar to that in FIG. 3B.

FIG. 11A shows the area around the recesses in the fifth embodiment of the vessel for cryopreservation by vitrification, including an enlarged perspective view of the side of said recesses with the apertures, and FIG. 11B shows a cross-sectional view of said recesses similar to that in FIG. 3B.

FIG. 12A shows a perspective view of a specialty well plate for advantageously quick and stable cryopreservation by vitrification processing holding two vessels for cryopreservation by vitrification, and FIG. 12B shows a top view of the specialty well plate.

FIG. 13A shows a perspective view of a variation in the specialty well plate for advantageously quick and stable cryopreservation by vitrification processing shown in FIGS. 12A and 12B, which is holding two vessels for cryopreservation by vitrification, and FIG. 13B shows a top view of said variation of the specialty well plate.

FIGS. 14A and B show the typical procedure for cryopreservation by the Cryotop method using eggs as example cells. FIG. 14A shows the global procedure, and FIG. 14B shows the stepwise procedure at the location shown by the X in FIG. 14A.

FIGS. 15A-C show the usage procedure for a cryopreservation vessel previously developed by the authors of this invention. FIG. 15A shows the global procedure, FIG. 15B shows an enlarged perspective of the area indicated by an X in FIG. 15A, and FIG. 15C shows a cross sectional view of FIG. 15B along the Y-Y plane.

### DETAILED DESCRIPTION

Next, the embodiments of the present invention will be explained with reference to the drawings, including a vessel for cryopreservation by vitrification in a liquid cryogen, a kit consisting of said vessel and a tube to store it in, as well as a method of cryopreservation by vitrification in a liquid cryogen. Furthermore, the embodiments which are explained below do not limit the invention within the scope of the claims. Also, the various elements and all combinations of elements involved in explanations of the embodiments are not necessarily mandatory to the present invention's solution.

### First Embodiment

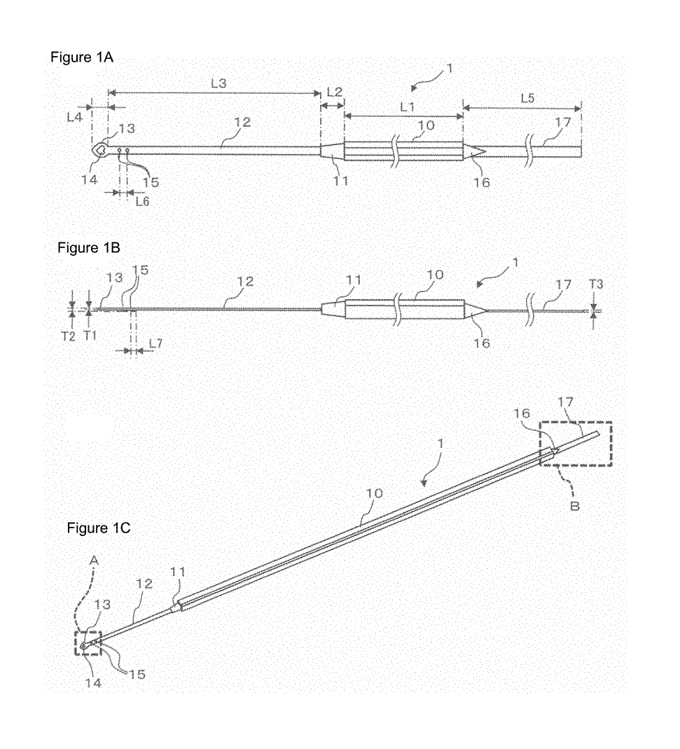

FIG. 1A shows a top view, FIG. 1B shows a side view, and FIG. 1C shows a perspective view of a vessel for cryopreservation by vitrification in a liquid cryogen in the first embodiment of the present invention.

A vessel for cryopreservation by vitrification in a liquid cryogen in the first embodiment (hereby referred to in the explanations of embodiments simply as “a vessel for cryopreservation by vitrification”) 1, is a vessel with a long shape in one direction. The vessel for cryopreservation by vitrification 1 has a structure at a location near the lengthwise end of said vessel where fertilized eggs (as an example of cells or embryos) can be retained. Furthermore, the vessel for cryopreservation by vitrification 1 may also retain cells or embryos other than fertilized eggs (cells or embryos will hereby be referred to as “cells etc.” where appropriate). In the embodiments below, fertilized eggs will primarily be used as a representative of cells etc. in examples for explaining cryopreservation by vitrification. The vessel for cryopreservation by vitrification 1 is a tool intended for the cryopreservation by vitrification of fertilized eggs that are retained on it. As shown in FIG. 1A, starting from the side near the location where the fertilized eggs are retained on the vessel for cryopreservation by vitrification 1 and moving towards the grip of the vessel for cryopreservation by vitrification 1, the vessel for cryopreservation by vitrification 1 is made up of the tip part 13, thin sheet part 12, connector 11, main grip 10, and grip 17, connected in that order.

The main grip 10 is preferably the part of the vessel for cryopreservation by vitrification 1 with the largest diameter; it is the main support component for the technician to support the vessel 1 by during the cryopreservation by vitrification process. In this embodiment the main grip 10 has a hexagonal cross-section, so it does not slip easily. Furthermore, the cross-sectional shape of the main grip 10 is not limited to being hexagonal; it may also be a triangle, a square, a pentagon, any polygon with 7 sides or more, or a circle. The length of the main grip 10 is not particularly restricted, but it is preferably within 10-200 mm, more preferably within 40-120 mm, and still more preferably within 60-100 mm. Additionally, the width (or height) of the main grip 10 is not particularly restricted, so long as it is easy for the technician to support the vessel by, but it is preferably within 1-5 mm, and more preferably within 1.5-2.5 mm.

The connector 11 is shaped like a truncated cone which gradually increases in diameter from the thin sheet part 12 towards the main grip 10. The purpose of the connector 11 is to connect the thin sheet part 12 and the main grip 10. The length (L2) of the connector 11 is not particularly restricted, but it is preferably within 0.5-5 mm, more preferably within 1-3 mm, and still more preferably within 1.5-2.5 mm. Additionally, the diameter of the main grip 10 side of the connector 11 is smaller than the width (or height) of the main grip 10; it is preferably within 0.8-4 mm, and more preferably within 1.2-2 mm. Additionally, the diameter of the connector 11 on the thin sheet part 12 side is smaller than the diameter on the main grip 10 side, preferably within 0.4 mm-2 mm, more preferably within 0.8-1.4 mm.

The thin sheet part 12 is the retaining part which retains fertilized eggs, and is preferably located near the end in the long direction of the vessel for cryopreservation by vitrification 1. The thin sheet part 12 is a flat component which preferably has a smaller thickness than the smallest diameter of the connector 11. There are two recesses 15 along the lengthwise direction of the thin sheet part 12 to insert fertilized eggs into at a location near the tip part 13 of the thin sheet part 12. However, there may also be only one recess 15, or 3 or more. Additionally, the recesses 15 may be aligned on the thin sheet part 12 in the crosswise direction. The recesses 15 preferably have apertures on one side of the thin sheet part 12, and said apertures preferably have a depth that surpasses the sheet thickness. In other words, the recesses 15 have apertures on one face of the thin sheet part 12 and outward protrusions on the reverse face.

The length (L3) of the thin sheet part 12 is not particularly restricted, but it is preferably within 3-50 mm, more preferably within 10-30 mm, and still more preferably within 15-25 mm. Additionally, the width of the thin sheet part 12 is preferably within 0.1-2 mm, more preferably within 0.3-1.5 mm, and still more preferably within 0.5-1 mm. The thickness (T1) of the thin sheet part 12 is preferably within 0.02-1 mm, more preferably within 0.05-0.3 mm, and still more preferably within 0.07-0.12 mm. The length (L3) and thickness (T1) of the thin sheet part 12 preferably exist in a combination that allows the thin sheet part 12 to bend sufficiently easily, with consideration for the constituent material. As for creating a highly flexible design, it is easier to insert a fertilized egg into a recess 15 when the thin sheet part 12 has the ability to bend to a near-horizontal state when dipping the recesses 15 on the vessel for cryopreservation by vitrification 1 into a shallow culture plate etc. containing fertilized eggs in vitrification solution. The depth of the recesses 15 is preferably within 0.06-3 mm, more preferably within 0.1-0.8 mm, and still more preferably within 0.15-0.5 mm. It is preferable to consider the size of the fertilized eggs to be retained with regards to the depth of the recesses 15 so that it is deep enough to easily retain the fertilized eggs etc., and shallow enough to easily remove them after thawing.

There are no particular restrictions on the distance between two recesses 15 (distance between the centers of the apertures: L6), so long as the two recesses 15 can fit on the length of the thin sheet part 12, but the distance is preferably within 0.4-2 mm, and more preferably within 0.8-1.4 mm. The distance L6 is preferably a suitable distance for dipping the two recesses 15 into the vitrification solution when bending the thin sheet part 12 into a culture plate etc., and a distance that does not allow the recesses 15 to contact each other during manufacture or use so that they maintain independent shapes. The outer diameter (L7) of a recess 15 may be any size that is able to store one fertilized egg, and is not so big as to overlap with an adjacent recess 15, preferably within 0.3-2 mm, more preferably within 0.4-1.5 mm, and still more preferably within 0.5-1 mm.

The tip part 13 is closer to the tip of the thin sheet part 12 than the recesses 15; it is a shock-mitigating part that acts to absorb shocks that are generated from the tip of said thin sheet part 12. The tip part 13 is a substantially annular sheet that has a hole 14 which passes through it in the thickness direction. In this embodiment, the hole 14 is heart-shaped, but it may also have a different shape. Additionally, an aperture consisting of two crescent shaped sheets may also be used in place of a hole 14. The tip part 13 may also have a honeycomb structure.

The length (L4) of the tip part 13 is not particularly restricted so long as it does not interfere when a recess 15 is retaining a fertilized egg, and the length is sufficient to absorb shocks to the fertilized eggs in the recesses 15 during cryopreservation, but it is preferably within 0.5-5 mm, more preferably within 0.7-3 mm, and still more preferably within 1-2 mm. The width of the tip part 13 is preferably within 0.5-5 mm, more preferably within 0.7-3 mm, and still more preferably within 1-2 mm. In this embodiment, the width of the tip part 13 is wider than the width of the thin sheet part 12. The thickness of the tip part 13 is preferably within 0.02-1 mm, more preferably within 0.05-0.3 mm, and still more preferably within 0.07-0.12 mm. In this embodiment, the thickness of the tip part 13 is roughly the same as the thickness of the thin sheet part 12.

The grip 17 is not the part that is normally held when using the vessel for cryopreservation by vitrification 1; rather, it is the part that is held when inserting the vessel for cryopreservation by vitrification 1 into a tube (described below) which is immersed in a cryogen such as liquid nitrogen. The grip 17 comprises the end part located on the side of a vessel for cryopreservation by vitrification 1 opposite the tip part 13. The grip 17 is a flat part which is not as thick as the main grip 10. The grip 17 is preferably fixed to the main grip 10 via a conical part 16 whose base faces the main grip 10. The conical part 16 mitigates the abrupt change in thickness between the main grip 10 and the grip 17, making it easier to manufacture, and helping prevent the grip 17 from snapping off at the base during use.

The length (L5) of the grip 17 is not particularly restricted, but it is preferably within 5-90 mm, more preferably within 10-60 mm, and still more preferably within 20-40 mm. Additionally, the width of the grip 17 is preferably within 0.5-5 mm, more preferably within 0.7-3 mm, and still more preferably within 1-2 mm. The thickness (T3) of the grip 17 is preferably within 0.02-1 mm, more preferably within 0.05-0.3 mm, and still more preferably within 0.07-0.12 mm. In this embodiment, the grip 17 has the same thickness as the thin sheet part 12.

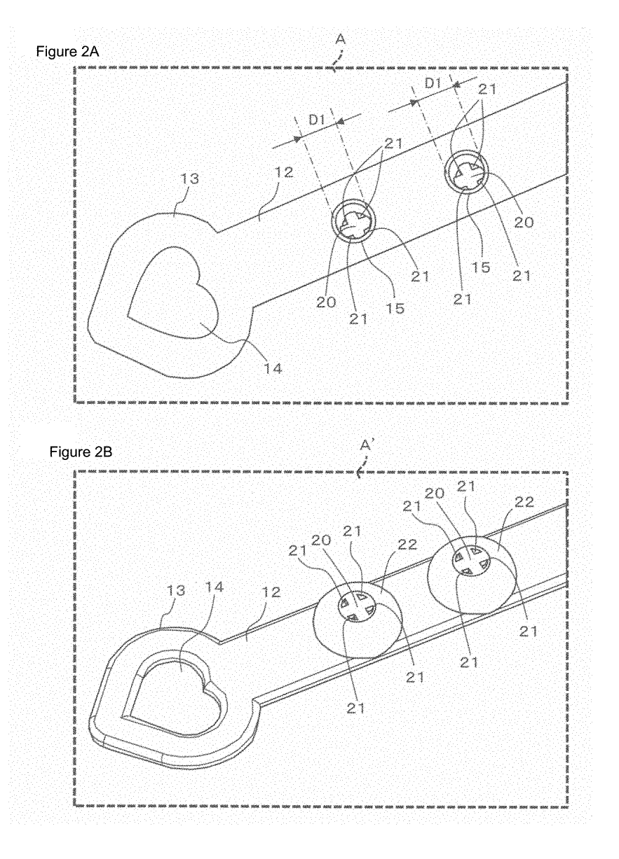

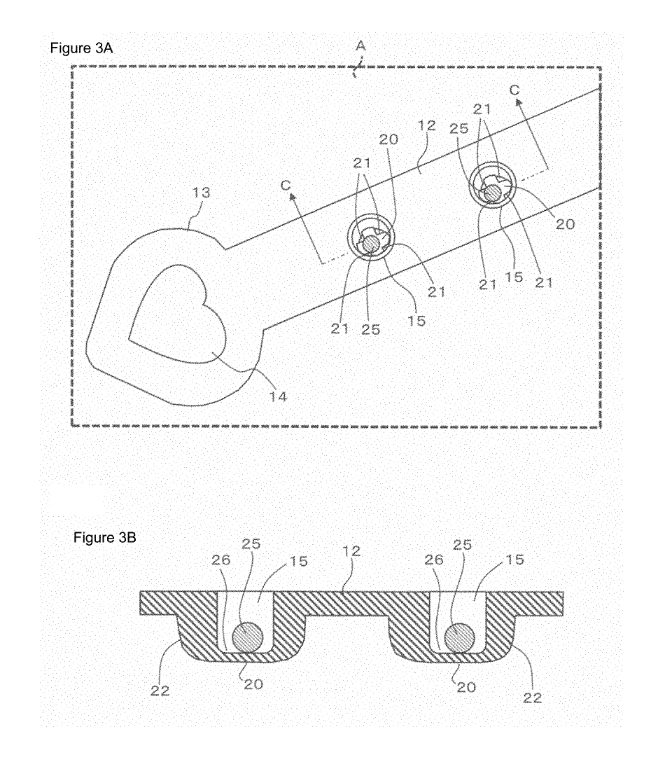

FIG. 2A shows an enlarged view of area A in FIG. 1C, and FIG. 2B shows an enlarged view of A′, which is area A after it has been turned over. FIG. 3A shows the recesses in FIG. 2A with fertilized eggs in them and FIG. 3B shows a cross sectional view along the C-C plane including the two recesses as they appear in FIG. 3A.

The recesses 15 in the thin sheet part 12 are cylindrical holes with a diameter on the side with the apertures of D1. The diameter D1 allows for easy retention of a fertilized egg 25, and preferably it is of a size that does not allow multiple fertilized eggs 25 to be stored side by side along the diameter of the hole. Considering that a fertilized egg 25 is approximately 0.1 mm, the diameter D1 of the recesses 15 is preferably within 0.15-0.6 mm, and more preferably within 0.2-0.4 mm. However, the diameter D1 of the recesses 15 may be changed as appropriate based on the size of the cells etc. that are to be retained. The diameter D1 is smaller than the outer diameter L7 described above. In other words, the recesses 15 have a side wall 22 which is sufficiently thick in the direction of the diameter D1. The most suitable size of the side wall 22 is 0.225 mm, when the diameter D1 of a recess 15 is 0.25 mm, and the outer diameter L7 is 0.7 mm. It is easy for the recesses 15 to retain their shape as per the design when a vessel for cryopreservation by vitrification 1 is formed in a mold if a side wall 22 is made to be thick. In other words, it lowers the chances of the collapse or deformation of recesses 15.

A recess 15 in this embodiment is substantially cup-shaped, and there are four holes 21, which are apertures in the bottom 26, and which do not allow all cells or embryos to pass through while still allowing vitrification solution to pass through. In more concrete terms, a recess 15 possesses a cross-shaped band 20 as its bottom 26. The holes 21 are made up by gaps in the bottom 26 and the cross-shaped band 20. So long as the holes 21 are of a size which does not allow a fertilized egg 25 to pass through, but does allow vitrification solution to pass through, the size is not particularly restricted. In this embodiment, the length of a straight section of a fan-shaped hole 21 is preferably within 0.01-0.1 mm, and more preferably within 0.02-0.07 mm. A cross-shaped band 20 that makes up the bottom 26 of a recess 15 retains a fertilized egg 25 in a recess 15 without allowing it to drop, this cross-shaped band functions to allow excess vitrification solution to discharge through the bottom 26 of a recess 15. An example of the band width of a cross-shaped band 20 is 0.1 mm. A recess 15 preferably possesses an internal volume of 30 nL or less when its holes 21 are blocked. As an example of this embodiment, a recess 15 with an internal diameter of a (D1, referred to above) of 0.25 mm and depth of 0.2 mm has an internal volume of said recess is 10 nL. Furthermore, the internal volume of a recess 15 indicates the internal volume if the holes 21 are hypothetically blocked. This meaning is shared in the other embodiments.

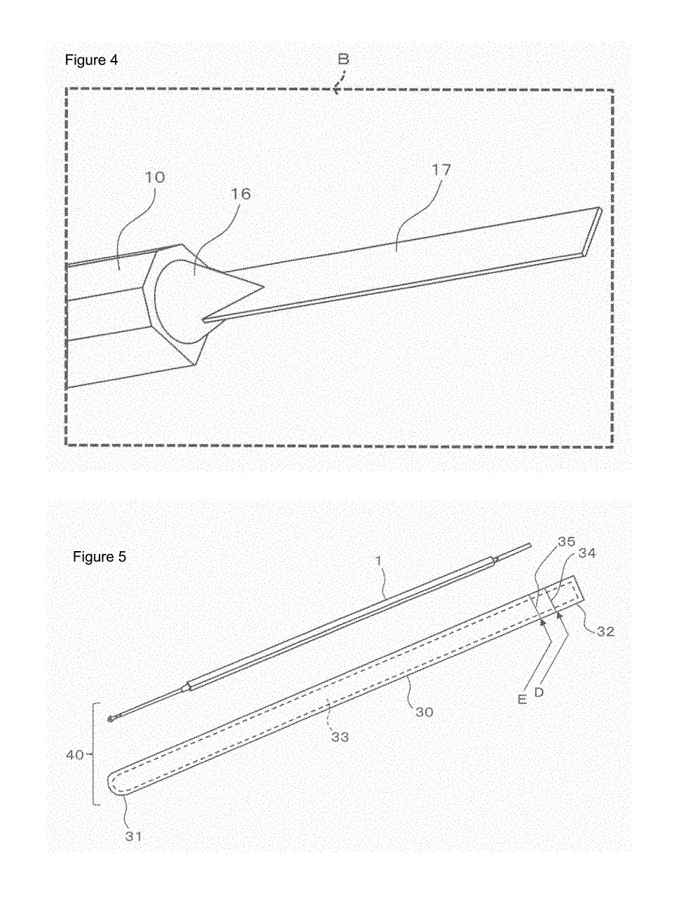

FIG. 4 shows an enlarged view of location B in FIG. 1C.

The grip 17 is fixed to the conical part 16, and part of the grip 17 is buried in the point of the conical part 16. The grip 17 and conical part 16 may be separate components, where the grip 17 is adhered to or inserted into the conical part 16, but the grip 17 and conical part 16 are preferably made up of a single component. As referred to above, the grip 17 is the component that the technician holds the device by when inserting a vessel for cryopreservation by vitrification 1 into a tube that is in a cryogen such as liquid nitrogen. In addition to this, in this embodiment, the grip 17 is the location where said tube seals when a vessel for cryopreservation by vitrification 1 inserted part-way into said tube in the lengthwise direction. The details of this are described below.

A vessel for cryopreservation by vitrification 1 is ideally made up of a synthetic resin such as polyamide; polyimide; cyclic olefin copolymer; a polyolefin such as polyethylene, polypropylene, ethylene-propylene copolymer, or ethylene-vinyl acetate copolymer; a polyester such as polyethylene terephthalate, polybutylene terephthalate, polyethylene naphthalate, or polybutylene naphthalate; or a polystyrene such as polystyrene, or methacrylate-styrene copolymer. Of these, cyclic olefin copolymers or polyamides are particularly good materials for a vessel for cryopreservation by vitrification 1 as they can be used in an extremely low temperature environment. Additionally, a vessel for cryopreservation by vitrification 1 may be manufactured from a material other than the resins mentioned above, for example: metals such as aluminum, aluminum alloy, or stainless steel; ceramics such as alumina, or silicon nitride; or glass. A vessel for cryopreservation by vitrification 1 is ideally made by injection molding whereby a resin is injected into a mold. Additionally, when injection molding, molten resin may be fed into the mold while reducing pressure through vent holes that pass from the inside of the mold to the outside. A vessel for cryopreservation by vitrification 1 may also be manufactured by a manufacturing process other than injection molding, namely vacuum forming or pressure forming, where softened resin is put into a mold and formed. Additionally, a vessel for cryopreservation by vitrification 1 may be manufactured using a 3D printer.

FIG. 5 shows a perspective view of a kit that includes the vessel for cryopreservation by vitrification in FIGS. 1A-C and a tube that stores the thin sheet part of said vessel.

This embodiment of a kit 40 comprises the previously explained vessel for cryopreservation by vitrification 1 and a tube 30 to store said vessel. A tube 30 must at least be able to store the thin sheet part 12 which retains cells etc. in a vessel for cryopreservation by vitrification 1 during use. A tube 30 in a kit 40 must at the least be sterilized on the inside 33; a tube 30 is a bag in a sealed state at both ends in the lengthwise direction 31, 32. When using a tube 30 an end is torn off at a line 34 at a prescribed location D on one end 32 of said tube to open said end 32. In other words, said line 34 indicates the part of a tube 30 that is opened during use. An opened tube 30 may be put into a cryogen such as liquid nitrogen with the open side facing outwards.

A technician immerses a recess 15 on a vessel for cryopreservation by vitrification 1 in vitrification solution containing a fertilized egg 25 in a culture plate, and sucks up some vitrification solution containing a fertilized egg 25 using a pipette, and expels the vitrification solution containing a fertilized egg 25 into a recess 15 in vitrification solution using said pipette. When lifting a vessel for cryopreservation by vitrification 1 out of the vitrification solution in the culture plate, excess vitrification solution falls through holes 21 in the bottom 26 of a recess 15, and only an egg 25 and a small amount of vitrification solution remains in the recess 15. Afterwards, a technician quickly inserts said vessel for cryopreservation by vitrification 1 into a tube 30 in a cryogen from the tip part 13 side. Then, the aperture of said tube 30 is secured to a prescribed location along the lengthwise direction of the grip 17. Any commonly-known method of fixation can be used for securing said aperture to the grip 17. Examples of fixation methods include heat sealing and fixing with an adhesive. When opening a tube 30 to remove a vessel for cryopreservation by vitrification 1, said tube is opened along the line 35 located at the prescribed location E on said tube 30. Furthermore, the line 35 is farther towards the end 31 direction than the location where the grip 17 and aperture of said tube 30 are fixed. Here, the lines 34, 35 are preferably both printed visibly on the surface of said tube 30, but they do not necessarily have to be visible. Also, the lines 34, 35 may also be made by methods other than printing, for example, embossing. Furthermore, the prescribed locations D, E may be indicated using methods other than lines 34, 35, for example arrows.

A tube 30 is ideally constructed of a synthetic resin such as polyamide; polyimide; cyclic olefin copolymer; a polyolefin such as polyethylene, polypropylene, ethylene-propylene copolymer, or ethylene-vinyl acetate copolymer; a polyester such as polyethylene terephthalate, polybutylene terephthalate, polyethylene naphthalate, or polybutylene naphthalate; or a polystyrene such as polystyrene, or methacrylate-styrene copolymer. Of these, cyclic olefin copolymers or polyamides are particularly good materials for a tube 30 as they can be used in an extremely low temperature environment. Also, a tube 30 may be made up of materials other than the resins mentioned above, for example rubbery elastomers such as silicone rubber; metals such as aluminum, aluminum alloy, or stainless steel; ceramics such as alumina, or silicon nitride; or glass.

As stated above, the inside of a tube 30 in sealed condition has been sterilized before use; when the thin sheet part 12 of a vessel for cryopreservation by vitrification 1 is retaining a fertilized egg 25, the tube 30 is used by inserting the end of said vessel for cryopreservation by vitrification 1 that has the thin sheet part 12 (in this embodiment, the tip part 13) into the opened end (32) of said tube 30 and sealing the tube 30 after the thin sheet part 12 has passed through to the prescribed location. In this embodiment, a vessel for cryopreservation by vitrification 1 is inserted into the inside of a tube 30, and then it is possible to seal said tube 30 at the aforementioned prescribed location, which is a location part-way along the length of the grip 17.

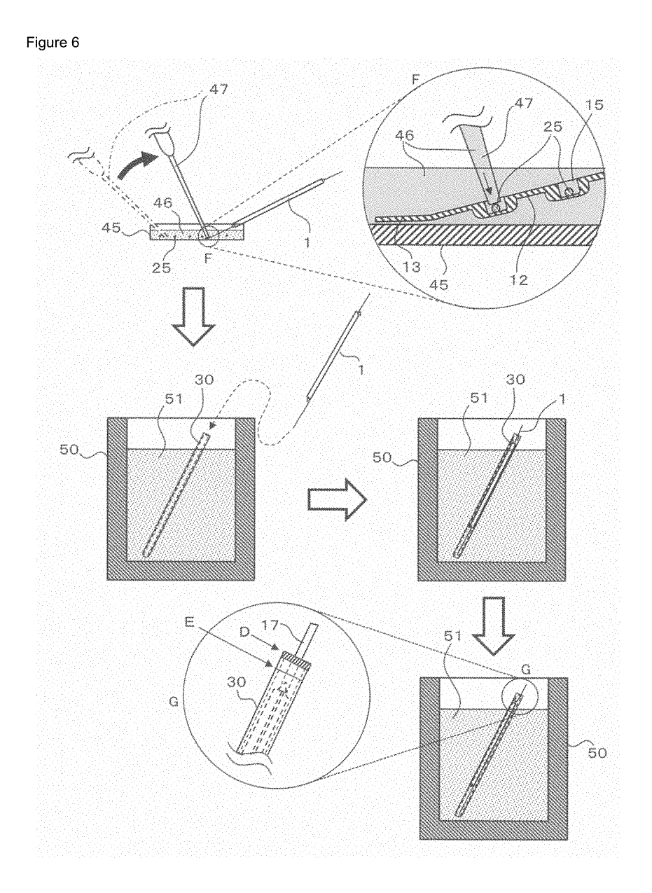

FIG. 6 shows a schematic outline which explains this embodiment of a method of cryopreservation by vitrification (method of cryopreservation by vitrification in a liquid cryogen) of fertilized eggs using a vessel for cryopreservation by vitrification. Furthermore a “method of cryopreservation by vitrification in a liquid cryogen” will hereby be referred to simply as a “method of cryopreservation by vitrification” in the embodiments below.

### (1) Equalization of Cryoprotectants

First, a fertilized egg will be placed in an equilibrium solution. An example of an equilibrium solution is a solution containing cryoprotectants (antifreeze agent concentration: 5-15% v/v). It is preferably to use a vitrification solution with a lower concentration of antifreeze agents than the vitrification solution in the previously described example as an equilibrium solution. An example equilibrium solution is prepared using sodium chloride, potassium dihydrogenphosphate, potassium chloride, calcium chloride, magnesium sulfate heptahydrate, 19 kinds of amino acids, sodium bicarbonate, ethylenediaminetetraacetic acid (EDTA) disodium dihydrate, gentamicin sulfate, polyvinyl alcohol, L-alanyl-L-glutamine, and HEPES (4-(2-hydroxyethyl)-1-piperazineethanesulfonic acid)-containing culture medium which also contains D-glucose, lactates such as sodium DL-lactate, and pyruvates such as sodium pyruvate as energy sources, as well as molecules with low molecular weight that demonstrate permeate into cells and have cryoprotective activity such as ethylene glycol, propylene glycol, glycerol, and dimethyl sulfoxide (DMSO) with a final concentration in vitrification solution of 50% v/v. As a result, antifreeze agents will permeate into a fertilized egg 25 at a concentration which does not have negative effects on fertilized eggs 25. Furthermore, antifreeze agents other than DMSO may be used due to concerns over the toxicity of DMSO to cells etc.; for example ethylene glycol alone, propylene glycol alone, or a mixture of them may be used.

(2) Permeation of Fertilized Eggs with Vitrification Solution

Next, vitrification solution 46 is prepared, and a fertilized egg 25 from the previous step is transferred to said vitrification solution 46 in a culture plate 45. Vitrification solution 46 has a high concentration of antifreeze agents (for example, concentration: 15-30% v/v) compared to an equilibrium solution as described above. This creates a difference in osmotic pressure between the equilibrium solution and vitrification solution 46 inside and outside of a fertilized egg 25, which causes dehydration of the free water or bound water (hereby referred to as “free water etc.”) in a fertilized egg 25. In this way, the free water etc. in a fertilized egg 25 is displaced with antifreeze agents, and there will be a high concentration of antifreeze agents in the fertilized egg 25. Furthermore, two or more steps (for example, 3 steps) may also be used in order to gradually change the concentration of antifreeze agents during the step where free water etc. in a fertilized egg 25 is displaced by vitrification solution 46. In addition, the concentration of antifreeze agents in the vitrification solution 46 is not limited to being within the concentration range described above, so long as the vitrification solution 46 is at a concentration where it can solidify in an amorphous state during rapid freezing, and it does not have a distinctly bad effect on a fertilized egg 25. Furthermore, the total concentration of antifreeze agents necessary for vitrification is dependent on the freezing speed, and freezing speed is determined by the volume at the time of vitrification. Due to this, it is preferable to use a cryopreservation vessel that uses as small a volume of vitrification solution as possible.

### (3) Storing Fertilized Eggs in a Vessel for Cryopreservation by Vitrification

Next, a vessel for cryopreservation by vitrification 1 is submerged in vitrification solution 46 in a culture plate 45 starting from the tip part 13 until it is submerged up to part-way up the thin sheet part 12, as shown in FIG. 6. As a result, the two recesses 15 are put completely under the surface of the vitrification solution 46. Using an available hand, vitrification solution 46 containing a fertilized egg 25 is sucked up into a pipette 47, and the tip of said pipette 47 is brought close to a recess 15, whereupon the fertilized egg 25 is expelled into the recess 15 (see the enlarged view at location F in FIG. 6). This operation is repeated once for each recess 15. The thin sheet part 12 is made up of a highly flexible material. Due to this, the recesses 15 can be made to be approximately parallel to the surface of the vitrification solution 46, which can make it easier to put a fertilized egg 25 in a recess 15.

One advantage of this embodiment of a vessel for cryopreservation by vitrification 1 is that it is possible to store a fertilized egg 25 in vitrification solution 46 in a vessel for cryopreservation by vitrification 1 without it contacting air. This advantage is absent in technologies that use a thin sheet part 12 which has holes that pass through it in the thickness direction wherein said thin sheet part 12 retains a fertilized egg 25 using the surface tension of the vitrification solution 46, or technologies that use a sheet equivalent to a thin sheet part 12 that is made up of a layer that absorbs vitrification solution 46 in which a fertilized egg 25 is retained on the surface of said layer. In this way, the amount of time that a fertilized egg 25 in vitrification solution 46 is in contact with air is kept as low as possible, which protects said fertilized egg 25 against drying, thus lowering the chances of changes in pH, temperature, or osmotic pressure occurring during the cryopreservation by vitrification process. This results in an increased survival rate for the fertilized eggs 25.

### (4) Super Rapid Cooling

A container 50 is filled with liquid nitrogen, as an example of a cryogen 51, and a tube 30 is placed in the cryogen 51. At this time, the aperture of the tube 30 is maintained above the cryogen 51. Next, a vessel for cryopreservation by vitrification 1 with a fertilized egg 25 in it is removed from the vitrification solution 46, and the end of said vessel is placed into said tube 30 that is immersed in said cryogen 51. At this time, within 1-90 seconds, preferably within 1-60 seconds, more preferably within 1-30 seconds of removing said vessel for cryopreservation by vitrification 1 from the vitrification solution 46, it is inserted directly into a tube 30 that is immersed in the cryogen 51. When using liquid nitrogen as a cryogen 51, a fertilized egg 25 in a recess 15 will rapidly be cooled to the extremely low temperature of approximately −196° C.

Another advantage of a vessel for cryopreservation by vitrification 1 is that a vessel for cryopreservation by vitrification 1 can easily retain a fertilized egg 25, so skill and experience are not needed. When retaining a fertilized egg 25 in open-air using a conventional vessel for cryopreservation by vitrification, it may be necessary to repeat the retention operations, as a fertilized egg 25 may not be retained normally, or it may fall after being retained normally. However, when using this embodiment of a vessel for cryopreservation by vitrification 1 to retain a fertilized egg 25, a fertilized egg 25 may simply be stored in a recess 15, and there is virtually no cause for repeating the retention procedure. Also, this simple procedure alleviates the need for training skilled technicians, which may help to lower the cost of cryopreservation by vitrification.

Additionally, this embodiment of a vessel for cryopreservation by vitrification 1 can be put directly into a cryogen 51, but it is more preferable to put it into a tube 30 that is immersed in the cryogen 51 and standing up on an angle. The risk of a fertilized egg 25 falling out of a recess 15 can be decreased by avoiding direct contact between a vessel for cryopreservation by vitrification 1 and the cryogen 51. A vessel for cryopreservation by vitrification 1 retaining a fertilized egg 25 may also be first inserted into a tube 30 then immersed in a cryogen 51. However, in this case, the cooling speed of said fertilized egg 25 may be decreased. In this embodiment, a container, for example an aluminum container, is placed into a cryogen 51 in advance, and a tube 30 is placed into said container and is maintained at an extremely low temperature. Due to this, the temperature of the air in a tube 30 is approximately the same as the temperature of said cryogen 51. Afterwards, the only operation needed to complete the cryopreservation process is inserting a vessel for cryopreservation by vitrification 1 retaining a fertilized egg 25 into said tube 30. A fertilized egg 25 can be rapidly frozen by this operation. Furthermore, a tube 30 is sterilized and sealed before use. Due to this a fertilized egg 25 can be cryopreserved in a sterile environment. Additionally, while holding the grip 17 a technician slowly inserts the tip part 13 of a vessel for cryopreservation by vitrification 1 into the aperture of a tube 30 and continues inserting said vessel for cryopreservation by vitrification 1 until said vessel reaches the end 31 opposite the aperture of said tube 30. This can decrease the risk of a fertilized egg 25 falling.

### (5) Tube Sealing

Next, the aperture or a prescribed location D near the aperture of a tube 30 is sealed at an arbitrary location along the length of the grip 17 (see enlarged view location G in FIG. 6). Even if a vessel for cryopreservation by vitrification 1 is inserted forcefully into a tube 30, since the tip part 13 functions as a shock-mitigating part there is little danger that a fertilized egg 25 will fall out of a recess 15 or that there will be a negative effect on a fertilized egg 25. Furthermore, the tube 30 may be affixed to the prescribed location D on the grip 17 so as to prevent the tip part 13 from contacting the end 31 opposite the aperture of a tube 30. In this way, the risk of a fertilized egg 25 falling, or a negative effect on a fertilized egg 25 is decreased.

### (6) Other Processes

It is preferable to stick a small IC tag (for example, one manufactured by SK Electronics Co., Ltd.) onto a vessel for cryopreservation by vitrification 1 alongside a printed label sticker (for example, one manufactured by Brady Inc.). Sticking a small IC tag and printed label sticker onto a vessel for cryopreservation by vitrification 1 allows for accurate and simple management of said vessel. Also, when removing a frozen vessel for cryopreservation by vitrification 1 from a tube 30, said tube 30 is cut at prescribed location E on said tube 30 (see enlarged view G in FIG. 6) using a tool such as a straw cutter, and said vessel for cryopreservation by vitrification 1 is removed from said tube 30 by grasping it by the grip 17. This operation allows for the safe removal of a vessel for cryopreservation by vitrification 1 from a tube 30.

### Second Embodiment

Next, the second embodiment of the present invention will be explained. The second embodiment shares parts in common with the first embodiment, so the same reference signs and/or names are used for these parts, and duplicate explanations are omitted. The details of parts that are not in the explanation of the second embodiment are described in the first embodiment.

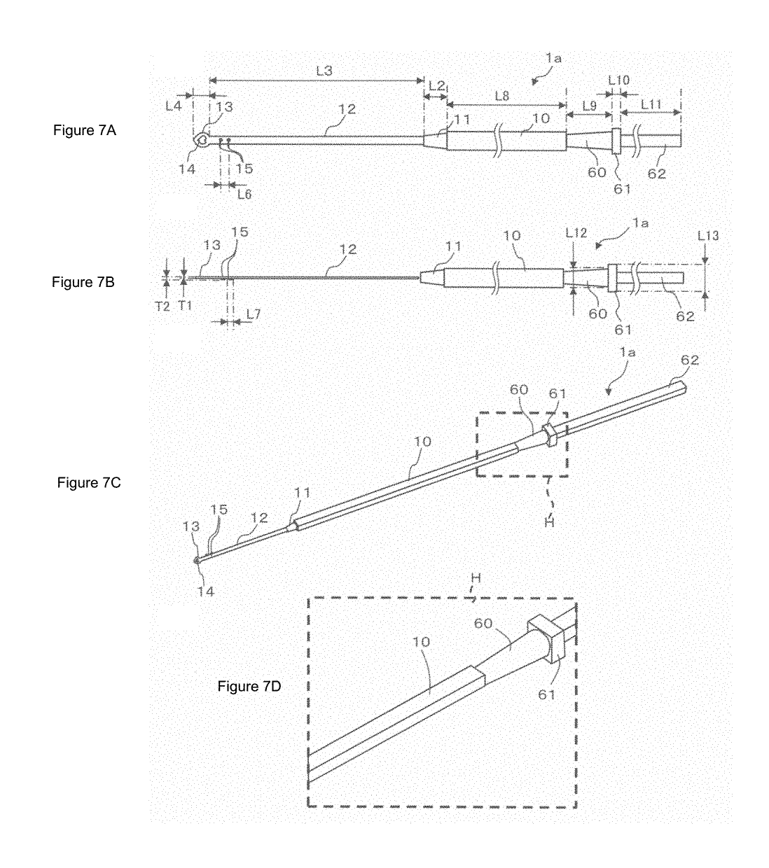

FIG. 7A shows the top view, FIG. 7B shows the side view, FIG. 7C shows the perspective view, and FIG. 7D shows an enlarged view of area H of the second embodiment of a vessel for cryopreservation by vitrification.

The second embodiment of a vessel for cryopreservation by vitrification 1a is a vessel which possesses a long shape in one dimension. A vessel for cryopreservation by vitrification 1a preferably has a structure that is able to retain a fertilized egg (as an example of cells or embryos) at a location close to the end of said long dimension. As shown in FIG. 7A, a vessel for cryopreservation by vitrification 1a comprises the following parts connected in the following order, from the end that retains fertilized eggs 25 to the other end of vessel for cryopreservation by vitrification 1a from which it is grasped: tip part 13, thin sheet part 12, connector 11, main grip 10, diameter expansion component 60, flange 61, and grip 62. The tip part 13, thin sheet part 12 and connector 11 are the same as in the first embodiment, so their descriptions will be omitted below.

The main grip 10 is the main support component by which the technician supports the vessel for cryopreservation by vitrification 1a. In this embodiment, the main grip 10 has a square cross-section which makes it difficult to slip. Furthermore, the cross-sectional shape of the main grip 10 is not limited to being a square; it may also be a triangle, a polygon with five or more sides, or a circle. The length (L8) of the main grip 10 is not particularly restricted, but it is preferably within 10-200 mm, more preferably within 20-100 mm, and still more preferably within 35-60 mm. Additionally, the width (or height) of the main grip 10 is not limited so long as it is of a size that is easy for a technician to hold, but it is preferably within 1-5 mm, and more preferably within 1.5-2.5 mm.

The end grip 62 side of the diameter expansion component 60, is thicker than the thin sheet part 12. The diameter expansion component 60 preferably has a truncated conical shape which gradually increases in diameter from the main grip 10 to the flange 61. In addition to its role in connecting the main grip 10 and the flange 61, the diameter expansion component 60 also plays a role in immobilizing the tube mentioned below. The length (L9) of the diameter expansion component 60 is not particularly restricted, but it is preferably within 1-30 mm, more preferably within 2-15 mm, and still more preferably within 4-10 mm. Also, the diameter of the diameter expansion component 60 on the main grip 10 side is preferably either smaller or the same as the width (or height) of the main grip 10; in more concrete terms, it is preferably within 0.7-5 mm, and more preferably within 1-2.5 mm. Additionally, the diameter (L12) of the diameter expansion component 60 on the flange 61 side is preferably either smaller or the same as the width (or height) of the flange 61; in more concrete terms, it is preferably within 1-6 mm, and more preferably within 2-4 mm.

The flange 61 has a width (or height: L13) larger than the diameter (L12) of the flange 61 side of the diameter expansion component 60. The flange 61 functions as a stopper that prevents the tube described below from moving past it towards the end grip 62. Consequently, the flange 61 is preferably larger than the aperture of said tube. The width (or height: L13) of the flange 61 is preferably within 1.5-10 mm, and more preferably within 2-6 mm. The thickness (L10) of the flange 61 is preferably within 0.7-5 mm, and more preferably within 1-3 mm.

The end grip 62 may be gripped during the operation of a vessel for cryopreservation by vitrification 1a, but it is ordinarily used as a grip when placing a vessel for cryopreservation by vitrification 1a that has already been inserted into a tube (described below) into a cryogen 51 such as liquid nitrogen. The end grip 62 is located on the side of a vessel for cryopreservation by vitrification 1a opposite the tip part 13. The length (L11) of the end grip 62 is not particularly restricted, but it is preferably within 5-90 mm, more preferably within 10-60 mm, and still more preferably within 20-40 mm. Additionally, the width of the end grip 62 is not particularly restricted, but it is preferably approximately the same as the width of the main grip 10. The width of the end grip 62 is preferably within 0.5-5 mm, more preferably within 0.7-4 mm, and still more preferably within 1-3 mm.

A vessel for cryopreservation by vitrification 1a is preferably made from the same materials as the vessel for cryopreservation by vitrification 1 in the first embodiment: synthetic resin, metal, ceramic, or glass. Additionally, similarly to the first embodiment of a vessel for cryopreservation by vitrification 1, a vessel for cryopreservation by vitrification 1a is preferably manufactured by injection molding, vacuum forming, pressure forming, or 3D printing.

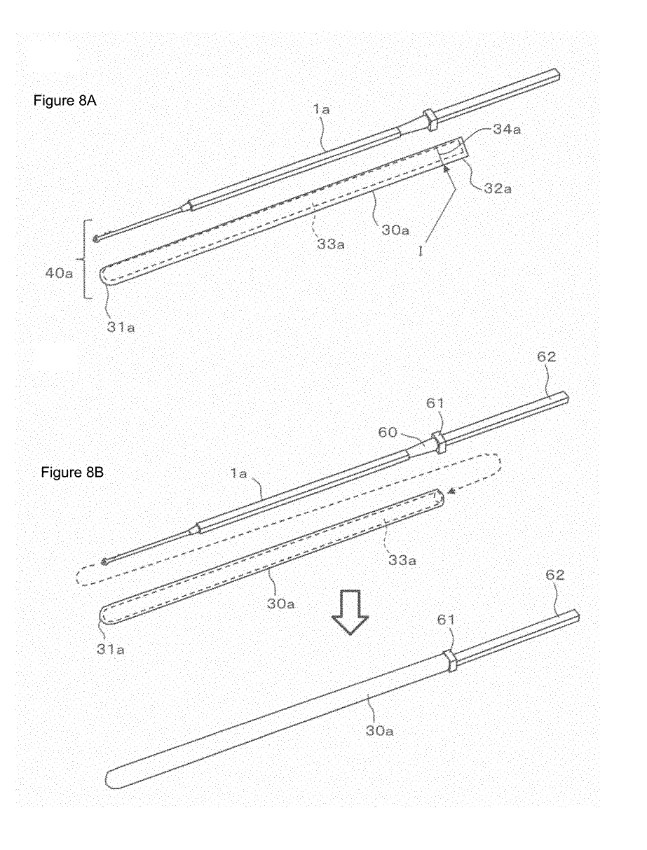

FIG. 8A shows a perspective view of a kit consisting of a vessel for cryopreservation by vitrification as shown in FIGS. 7A-D, and FIG. 8B shows a tube to store the thin sheet part of said vessel.

This embodiment of a kit 40a comprises a vessel for cryopreservation by vitrification 1a described above and a tube 30a to store said vessel. A tube 30a must at least be able to store the thin sheet part 12 of a vessel for cryopreservation by vitrification 1a during use. A tube 30a in a kit 40a must at least be sterilized on the inside 33a; a tube 30a is a bag in a sealed state at both ends 31a and 32a in the lengthwise direction. When using a tube 30a, an end is torn off at a line 34a at a prescribed location I on one end 32a of said tube to open said end 32a. In this embodiment, said line 34 a indicates the part of a tube 30a that is opened during use. An opened tube 30a may be put into a cryogen 51 such as liquid nitrogen with the open side facing outwards.

A technician quickly immerses a vessel for cryopreservation by vitrification 1a that has a fertilized egg 25 retained in a recess 15 into a tube 30a that is standing in a cryogen 51 immersing said vessel tip part 13 side-first. Afterwards, the technician affixes the aperture of said tube 30a to a prescribed location along the lengthwise direction of the diameter expansion component 60. As a result, said vessel is sealed in said tube 30a from the flange 61 to the tip part 13 side. When removing a vessel for cryopreservation by vitrification 1a from a tube 30a, a technician may hold the end grip 62 and pull said vessel for cryopreservation by vitrification 1a out of said tube 30a. Line 34a is preferably printed visibly on the surface of said tube 30a, but it does not necessarily have to be visible. Also, the line 34a may also be made by methods other than printing, for example, embossing. Furthermore, the prescribed location I may be indicated using methods other than line 34a, for example, arrows. A tube 30a may be made from the same materials as the vessel for cryopreservation by vitrification 1 in the first embodiment: synthetic resins, rubbery elastomers, metals, ceramics, or glass.

In this way a tube 30a can be affixed to a prescribed location on a diameter expansion component 60 where the thin sheet part 12 of a vessel for cryopreservation by vitrification 1a has passed into the inside of said tube 30a to be stored. In this embodiment the location where tube 30a is opened during use (prescribed location I) is shown. Due to this, by designing the opening position to be the location where said tube 30a is affixed on the diameter expansion component 60, a vessel for cryopreservation by vitrification 1a can be reliably stored in a tube 30a from the diameter expansion component 60 to the tip part 13.

The majority of the method for cryopreservation of a fertilized egg 25 by vitrification using a vessel for cryopreservation by vitrification 1a in this embodiment is similar to the first embodiment, so only the parts that differ will be explained below.

Steps (1) Equalization of cryoprotectants, (2) Permeation of fertilized eggs with vitrification solution, (3) Storing fertilized eggs in a vessel for cryopreservation by vitrification, and (4) Super rapid cooling for the method for cryopreservation by vitrification are the same in both the first and second embodiments.

### (5) Tube Sealing

The aperture (prescribed location I) of a tube 30a is pulled up to a location along the length of the diameter expansion component 60 or at a position contacting the flange 61. As a result, the insertion of a vessel for cryopreservation by vitrification 1a into said tube 30a, which is immersed in a cryogen, is complete.

### (6) Other Processes

Similar to the first embodiment of a vessel for cryopreservation by vitrification 1, a vessel for cryopreservation by vitrification 1a is preferably stored with a small IC tag and a printed label sticker. When removing a frozen vessel for cryopreservation by vitrification 1a from a tube 30a, said tube 30a can simply be pulled off without using a tool such as a straw cutter by pulling said tube 30a from the diameter expansion component 60 towards the tip part 13.

### Third, Fourth, and Fifth Embodiments

Next, the third, fourth, and fifth embodiments of the present invention will be explained. The third, fourth, and fifth embodiments share parts in common with the previously explained embodiments, so the same reference signs and/or names are used for these parts, and duplicate explanations are omitted. The details of parts that are not in the explanation of the third, fourth, and fifth embodiments are described in the previous embodiments.

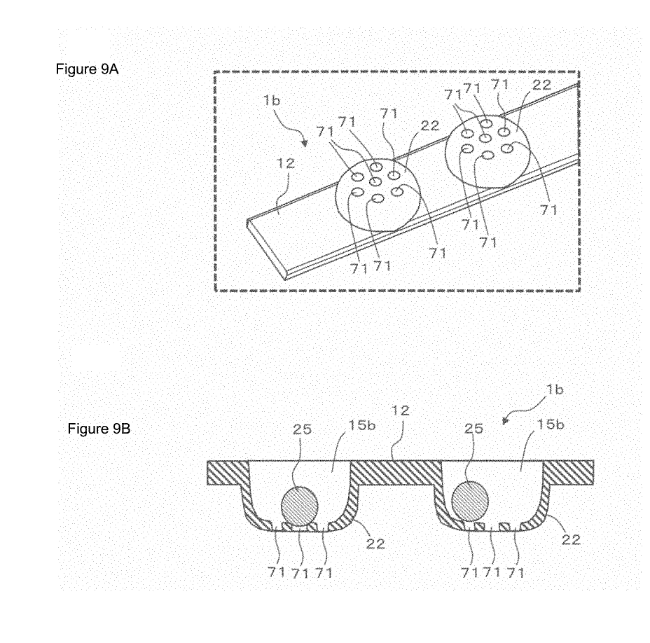

FIG. 9A shows an enlarged perspective view of the area near the recesses on the third embodiment of a vessel for cryopreservation by vitrification seen from the bottom side of said recesses and FIG. 9B shows a cross-sectional view similar to that in FIG. 3B of said recesses.

In the third embodiment of a vessel for cryopreservation by vitrification 1b, the recesses 15b have a different shape than those in the first embodiment of a vessel for cryopreservation by vitrification 1, and there is no shock-mitigating part that corresponds to the tip part 13. The structures are all the same as those in the first embodiment of a vessel for cryopreservation by vitrification 1 aside from said two structures.

The recesses 15b are substantially cup shaped on one side of the thin sheet part 12 in the thickness direction. The bottom of the recesses 15b have multiple (7, in this embodiment) holes 71. The holes 71 are preferably circular, but they may also be polygonal. The size of the holes 71 is not particularly restricted so long as the holes are of a size that does not allow a fertilized egg 25 to pass through them, but does allow vitrification solution 46 to pass through them. In this embodiment, the diameter of a hole 71 is preferably within 0.01-0.08 mm, and more preferably within 0.03-0.06 mm. Also, the side walls 22 of the recesses 15b are not excessively thick compared to those of the first embodiment. Though the recesses 15b are shaped as shown in FIG. 9, they can still store a fertilized egg 25 in vitrification solution 46 similarly to the previously described recesses 15, and when a vessel for cryopreservation by vitrification 1b is removed from the vitrification solution 46, excess vitrification solution 46 can be expelled out through the holes 71.

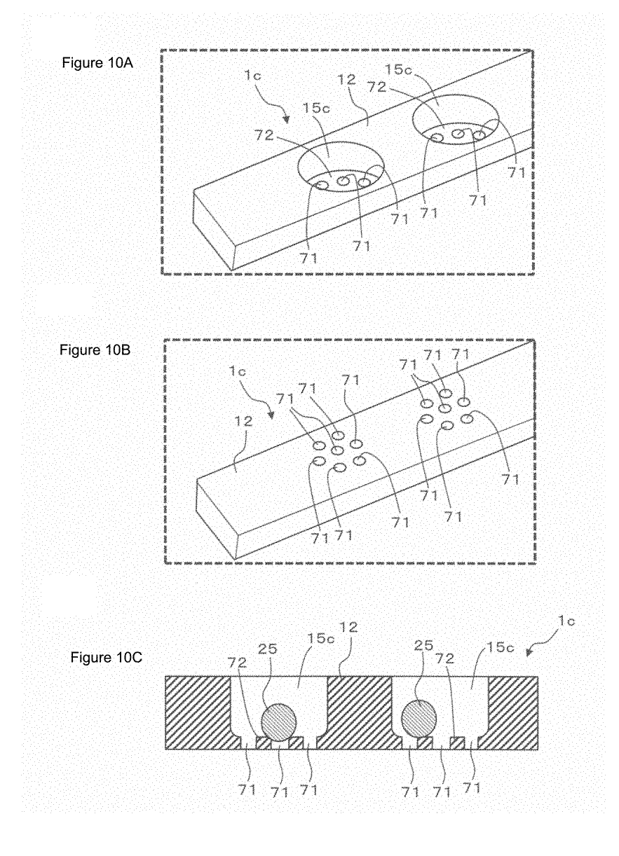

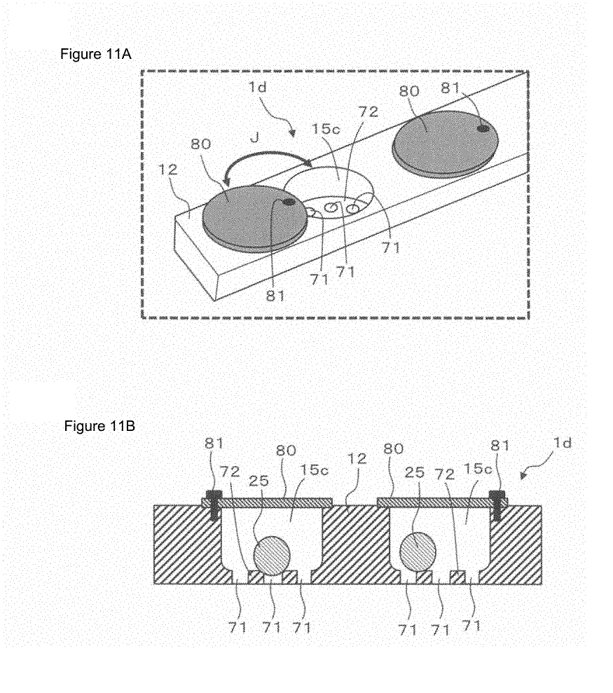

FIG. 10A shows an enlarged perspective view of the aperture side of the area near the recesses in the fourth embodiment of a vessel for cryopreservation by vitrification, FIG. 10B shows an enlarged perspective view of the bottom side of said recesses, and FIG. 10C shows a cross-sectional view of said recesses similar to that in FIG. 3B.

The fourth embodiment of a vessel for cryopreservation by vitrification 1c has differently shaped recess 15c than those in the first embodiment of a vessel for cryopreservation by vitrification 1, and there is no shock-mitigating part that corresponds to the tip part 13. The structures are all the same as those in the first embodiment of a vessel for cryopreservation by vitrification 1 aside from said two structures.

The recesses 15c are shaped so that they do not protrude from either side of the thin sheet part 12 in the thickness direction, and are hollow recesses within the thickness of the thin sheet part 12. The thin sheet part 12 requires a thickness that is equal to or greater than the recesses 15c, so the thin sheet part 12 is preferably thicker than those in the previously described embodiments. The bottoms 72 of the recesses 15c approximately flush with the thin sheet part 12, and they have multiple (7, in this embodiment) holes 71. The preferable size and shape for the holes 71 are the same as in the third embodiment. Also, the side walls of the recesses 15c share their structure with the thin sheet part 12. In this way, even though the recesses 15c are formed so that they do not protrude from the thin sheet part 12 and they are kept within the thickness of the thin sheet part 12, they can store a fertilized egg 25 in vitrification solution 46, and the excess vitrification solution 46 is expelled through the holes 71 when the vessel for cryopreservation by vitrification 1c is removed from the vitrification solution 46, just as the previously described recesses 15 do.

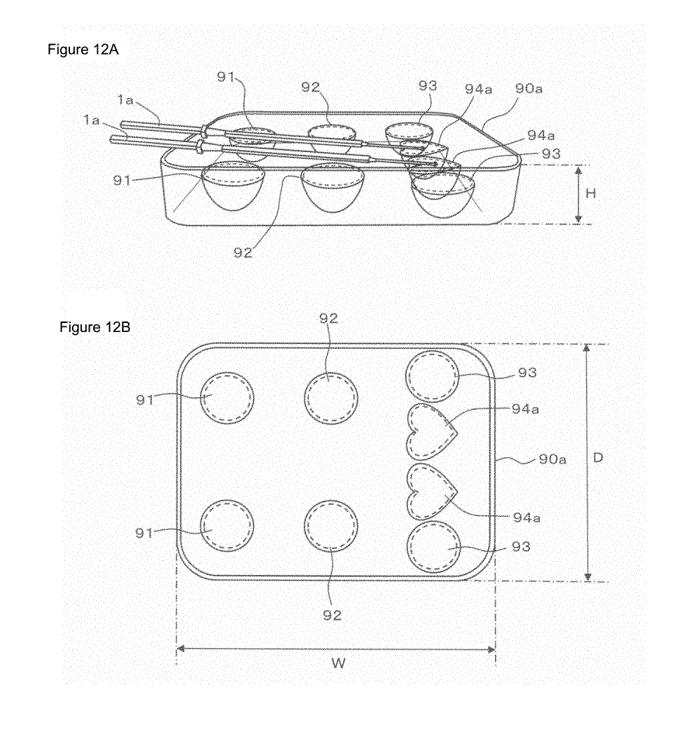

FIG. 11A shows the area around the recesses in the fifth embodiment of the vessel for cryopreservation by vitrification as an enlarged perspective view of the bottom of said recesses and FIG. 11B shows a cross-sectional view of the aperture side of said recesses similar to that in FIG. 3B.

The fifth embodiment of a vessel for cryopreservation by vitrification 1d differs from the fourth embodiment of a vessel for cryopreservation by vitrification 1c in that there is an openable lid 80 over the recesses 15c. Aside from this structure, it is the same as the fourth embodiment of a vessel for cryopreservation by vitrification 1c. A lid 80 overlaps part of the thin sheet part 12 around the edge. A lid 80 is pierced in the thickness direction by a pin 81. The pins 81 are fixed to the thin sheet part 12 in order to allow the lids 80 revolve around the center of a pin 81. A lid 80 is able to rotate in both directions indicated by the double-sided arrow J as shown in FIG. 11 (11A), which allows for the opening and closing of the apertures of recesses 15c. By means of the opening and closing of the lid 80 over the aperture of a recess 15c, the lid 80 seals a recess 15c directly after a fertilized egg 25 is put into said recess 15c, which makes certain to prevent contact between the fertilized egg 25 and the air while carrying the fertilized egg 25 to the cryogen 51; there is also no danger of said fertilized egg 25 falling from aperture of the recess 15c.

In this embodiment, there are two recesses 15c arranged beside each other along the lengthwise direction of the thin sheet part 12. Due to this, there is a possibility that the two lids 80 may collide with each other during opening and closing. In order to avoid this happening as much as possible, the two pins 81 should be as far away from each other as possible. In this way collisions between the two lids 80 can be prevented even when rotating the two lids 80 around the centers of the two pins 81. Furthermore, if there is a space of sufficient length between the recesses 15c, the pins 81 do not necessarily have to be in the locations indicated in FIG. 11.

### Preferable Usage Method for a Vessel for Cryopreservation by Vitrification

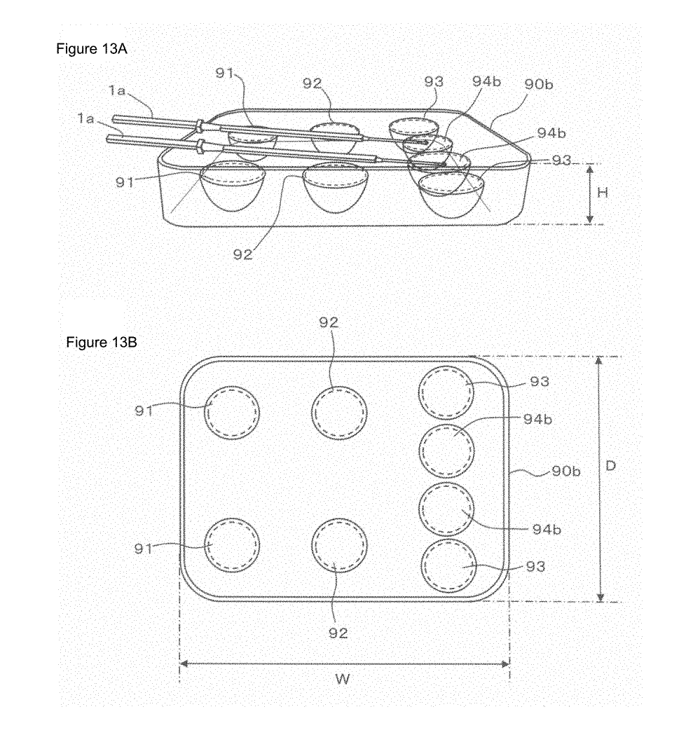

FIG. 12A shows a perspective view of a specialty well plate that is advantageous for quick and stable cryopreservation by vitrification processing holding two vessels for cryopreservation by vitrification, and FIG. 12B shows a top view of said specialty well plate. A specialty well plate is made up of an apparatus where one can set down the tip of a vitrification vessel in the vitrification solution in the tip storage area without holding said vessel in one's hand, and a configuration (shape, size, height, etc.) that allows on to complete all of the operations and observations safely and quickly without changing the focal point of a microscope.

The specialty well plate (referred to here as a “specialty well plate”) 90a shown in FIGS. 12A and B is a component that is preferably made from a resin or glass with high transparency, and which has openings on one face (the face depicted on the surface of the page in FIG. 12B). The specialty well plate 90a has two rows of substantially hemispherical wells 91, 92, 93, as well as two heart-shaped substantially hemispherical wells 94a on the opening side for a total of 8 placeable wells. Well 91 will hereby be referred to as the first well 91. Wells 92 and 93 will hereby be referred to as the second well 92 and second well 93, respectively. Well 94a will hereby be referred to as the third well. The ideal size for a specialty well plate 90a is as follows: width (W) of 85 mm×depth of (D) 65 mm×height (H) of 10 mm. Similar to the specialty well plate 90a, the first well 91, second wells 92, 93, and third well 94a are preferably made from a resin or glass with high transparency. The hemispherical first well 91 and second wells 92, 93 are preferably the same size, with a diameter of 15 mm. The height of the hemispherical first well 91 and second wells 92, 93 is preferably the same as the depth of the specialty well plate 90a or less than said depth, within 5-9 mm in this embodiment. As for the open side of a heart-shaped, substantially hemispherical third well 94a in this embodiment, the diameter of a circle in which the heart-shaped opening is inscribed is made to be 15 mm. However, the diameter of said circle may be larger than 15 mm, for example within 16-18 mm. Also, the diameter of said circle may be smaller than 15 mm, for example within 12-14 mm. The height on the open side of said heart-shaped hemispherical third well 94a is preferably the same as the depth of the specialty well plate 90a or less than said depth, within 5-9 mm in this embodiment.

As shown in FIG. 12B, one well array composed of a first well 91, two second wells 92, 93, and a third well 94a can be placed on the specialty well plate 90a in each area denoted by half the length in the depth (D) direction. In other words, a specialty well plate 90a has an operational line dividing the top and bottom of the surface shown in FIG. 12B. Due to this, the cryopreservation operations for two eggs (which may be either unfertilized eggs or fertilized eggs) may be conducted at the same time. In this embodiment, the first well 91 is for putting equilibrium solution in. In this embodiment, the second wells 92, 93 and the third well 94a are for putting vitrification solution in. The opening of the third well 94a is shaped like a heart; it is preferable that this be the same shape as the tip part of a vessel for cryopreservation by vitrification 1a. This allows a technician to clearly see that the third well 94a is the final immersion location, and it also considers the fact that most technicians who conduct cryopreservation by vitrification are women.

An example procedure for cryopreservation by vitrification of an egg using a specialty well plate 90a is described below.

Approximately 300 μl of equilibrium solution is dispensed into the two first wells 91, and approximately 300 μl of vitrification solution is dispensed into the four second wells 92, 93 and two third wells 94a. When dispensing vitrification solution into the third wells 94a, it is preferable to aim the pipette tip at the storage areas (recesses 15) mounted at the bottom of an empty third well 94a and expel the vitrification solution that was sucked up by the pipette in order to force the air out of the third well 94a so as to prevent air from entering the storage areas (recesses 15) in a vessel for cryopreservation by vitrification 1a. It is preferable to fill up the third wells 94a with vitrification solution after dispensing it in this way.

When an egg is expelled along with a small volume of culture medium using a pipette to transfer it onto the surface of the equilibrium solution in the first well 91, the expelled egg will shrink due to differences in osmotic pressure and viscosity from the added equilibrium solution protectants, the said egg will sink to the bottom of the first well 91 as it gradually acclimates. Afterwards, the egg is transferred to the vitrification solution in the second well 92 after confirming that the egg has returned to the size that it was before it was put into the equilibrium solution; a standard processing time is 10-15 minutes. The vitrification solution in the second well 92 has a comparatively higher concentration; there is a possibility that it will have a negative effect on the egg, so it is preferable to keep the processing time up until freezing within 90 seconds from this step onwards. Simply placing the egg in the vitrification solution in the second well 92 does not force the cryoprotectants to interact with the cell, which hampers the permeation of cryoprotectants throughout the cell. Thus, the egg should be swiftly moved to six or more locations in the bottom of the second well 92 by forcefully sucking up and expelling the egg using a pipette. Next, it is preferable that the egg is transferred to the vitrification solution in the second well 93, then swiftly moved to six or more locations in vitrification solution in the bottom of the second well 93 by forcefully sucking up and expelling the egg using a pipette. As a result, the egg will virtually completely acclimate to the vitrification solution. An egg that has been completely equilibrated with the vitrification solution is sucked up with a transfer pipette. Next, the storage area (recesses 15) of a vessel for cryopreservation by vitrification 1a, which has been filled with vitrification solution in advance, is transferred to a third well which is also 94a filled with vitrification solution. Following this, the tip of the pipette is brought down close to the inside of the storage area, and the egg is expelled into the vitrification solution.

Next, carefully lift the vessel for cryopreservation by vitrification 1a out of the third well 94a so that the egg does not come out of the storage area, then carefully insert the tip of said vessel for cryopreservation by vitrification 1a into a tube 30a that has been cooled in liquid nitrogen beforehand, so as to not create a shock. When performing the same operation with a vessel for cryopreservation by vitrification 1, insert the vessel for cryopreservation by vitrification 1 into a tube 30 that has been cooled in liquid nitrogen beforehand. Also, when not using a tube 30, 30a, it is preferable to gently immerse a vessel for cryopreservation by vitrification 1a, 1 as-is into liquid nitrogen.

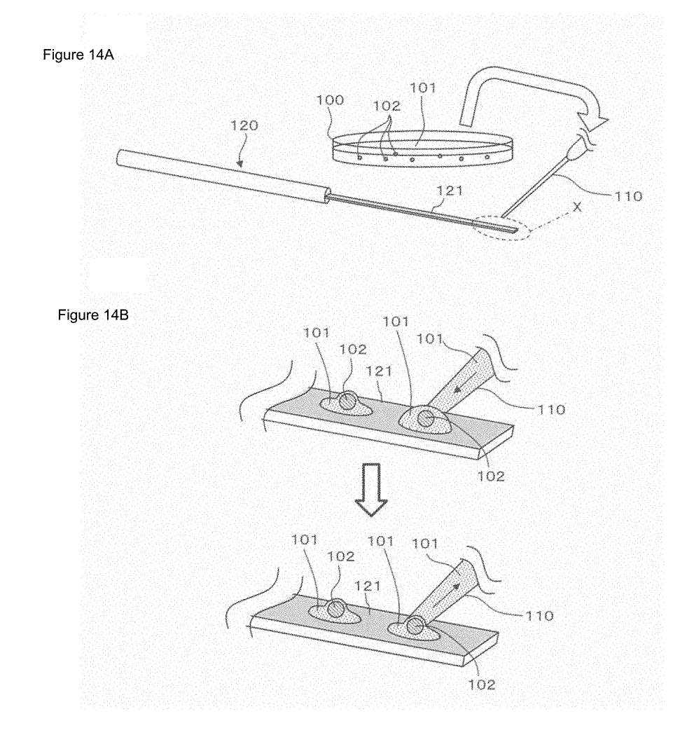

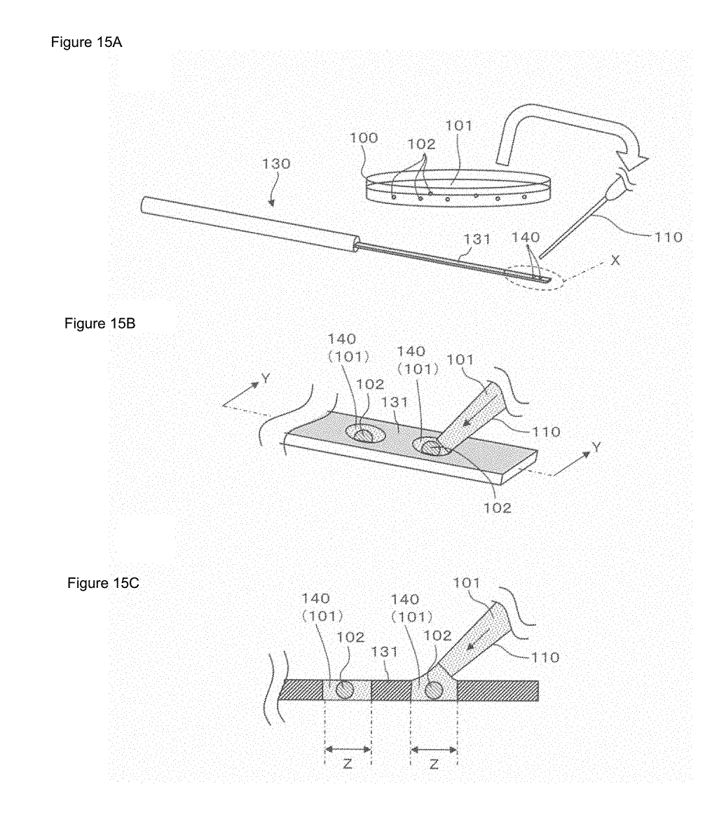

FIG. 13A shows a perspective view of an alternate example of the specialty well plate shown in FIGS. 12A and B that is advantageous for quick and stable cryopreservation by vitrification processing holding two vessels for cryopreservation by vitrification, and FIG. 13B shows a top view of said alternate specialty well plate.

The specialty well plate (referred to here as a “specialty well plate”) 90b shown in FIG. 13A is quite similar to the specialty well plate 90a, except that there are third wells 94b which are virtually identical to the first wells 91 and second wells 92, 93 in place of the third wells 94a shown in FIGS. 12A and B. The same operations described above can be used even when using the third wells 94b which have a circular opening in place of the heart-shaped opening of the third wells 94a.

As stated above, this embodiment of the method for the vitrification of cells or embryos first uses at least three of the following, which have same or smaller depth than the depth of the inner volume at the bottom surface of the open side of a specialty well plate 90a, 90b: first well 91, second wells 92, 93, and third well 94a (or 94b). One or more first well 91 contains equilibrium solution. Also, one or more second well 92, 93 contains vitrification solution. In addition, one or more third well 94a (or 94b) contains vitrification solution as well as the recesses 15 of a vessel for cryopreservation by vitrification 1a, 1 immersed in said vitrification solution. Next, cells or embryos are transferred from the first well 91, to the second wells 92, 93, to the third well 94a (or 94b) in that order. Next, a vessel for cryopreservation by vitrification 1a, 1 containing cells or embryos in its recesses 15 is lifted from the vitrification solution in the third well 94a (or 94b). Lastly, a vessel for cryopreservation by vitrification 1a, 1 with cells or embryos stored in its recesses 15 is immersed in a cryogen. This allows for accurate and quick storing of cells or embryos in the recesses 15 of said vessel using specialty well plate 90a, 90b with no need to continuously grip a vessel for cryopreservation by vitrification 1a, 1 in one's hand. Furthermore, the explanations of the operations involved in cryopreservation by vitrification using a specialty well plate 90a, 90b were described using a vessel for cryopreservation by vitrification 1a, 1 as an example, but the same operations may also be used when using a vessel for cryopreservation by vitrification 1b, 1c, 1d.

### Other Embodiments

The embodiments described above are only fitting embodiments of the present invention, and various alternatives may also be implemented so long as they do not deviate from the purpose of the present invention.

A vessel for cryopreservation by vitrification 1, 1a, 1b, 1c, 1d (hereby, “variant vessel for cryopreservation by vitrification 1”) may also be used to preserve cells other than fertilized eggs 25 (for example, unfertilized eggs) or embryos, for example. Additionally, recesses 15, 15b may have holes 21, 71 in the side walls 22 instead of the bottoms 26, 72 or in addition to the bottoms 26, 72. In other words, the location of holes 21, 71 are not particularly restricted, so long as they are in the walls that make up recesses 15, 15b. A cross-shaped band 20 need not only be used in recesses 15; it may also be used in recesses 15b, 15c. The inner volume of recesses 15, 15b, 15c with sealed holes 21, 71 is preferably 30 nl or less, but it may also be more than 30 nl and smaller than 50 nl. Furthermore, the inner volume of recesses 15, 15b, 15c may also be 50 nl or more. The retaining part that retains cells etc. may be a component with a shape other than that of a thin sheet part 12. For example, the shape of the retaining part may be a shape that is not flat such as a rod shape or a block shape.

In the embodiments described above, when expelling vitrification solution 46 and a fertilized egg 25 in a recess 15, 15b, 15c of a variant vessel for cryopreservation by vitrification 1, part or all of the thin sheet part 12 is to be submerged in the same solution as said expelled vitrification solution 46. However, the expelled vitrification solution does not have to be identical to the vitrification solution 46 in which the thin sheet part 12 of a variant vessel for cryopreservation by vitrification 1 is submerged. For example, one may prepare two culture plates, then submerge the thin sheet part 12 of a variant vessel for cryopreservation by vitrification 1 in the vitrification solution 46 in one culture plate, and suck up vitrification solution and a fertilized egg using a pipette 47 from the other culture plate, then expel said fertilized egg 25 and vitrification solution into a recess 15, 15b, 15c in the thin sheet part 12 and store the fertilized egg 25 in the recess 15, 15b, 15c.

As for the present invention, multiple components of the variant vessel for cryopreservation by vitrification 1 described above a kit 40, 40a, and method for cryopreservation by vitrification may be combined. An example of this is a combination of the first or second embodiment and the fifth embodiment, where these embodiments had lids 80 over the openings of their recesses 15. Also, as a combination of the second embodiment and the third embodiment, the second embodiment of a vessel for cryopreservation by vitrification 1a may have recesses 15b. Also, the diameter expansion component 60 of the second embodiment of a vessel for cryopreservation by vitrification 1a may also be used on the third-fifth embodiments of a vessel for cryopreservation by vitrification 1b, 1c, 1d. Furthermore, a kit 40 or kit 40a may contain the third-fifth embodiments of a vessel for cryopreservation by vitrification 1b, 1c, 1d. Furthermore, a vessel for cryopreservation by vitrification 1, 1a, 1b, 1c, 1d may also be used in open air; they need not only be used in cryopreservation solutions.

### FIELD OF INDUSTRIAL APPLICATION

The present invention can be used for the cryopreservation by vitrification of cells or embryos.

1. A vessel for cryopreservation by vitrification in a liquid cryogen which functions in the cryopreservation of cells or embryos contained in vitrification solution, the vessel comprising:
a retaining part configured to retain cells or embryos,
wherein said retaining part possesses one or more recesses configured to receive the cells or the embryos therein, and
one or more walls constituting said recesses possess one or more holes which do not allow the cells or the embryos to pass therethrough, but allow vitrification solution to pass therethrough.

2. The vessel for cryopreservation by vitrification in a liquid cryogen of claim 1 wherein said recesses comprise an aperture on one face of said retaining part, and an outward protrusion on a face opposite said apertures.

3. The vessel for cryopreservation by vitrification in a liquid cryogen of claim 1, further comprising a cross-shaped band at a bottom of said recesses, wherein said holes are made up of gaps in the cross-shaped band at the bottom of said recesses.

4. The vessel for cryopreservation by vitrification in a liquid cryogen of claim 1, wherein an internal volume of said recesses is 30 nl or less with said holes in a sealed state.

5. The vessel for cryopreservation by vitrification in a liquid cryogen of claim 1, further comprising a shock-mitigating part configured to dampen shocks added to said retaining part at a position closer to a tip of said vessel than said recesses in said retaining part.

6. The vessel for cryopreservation by vitrification in a liquid cryogen of claim 1, further comprising a grip on one end of the vessel.

7. The vessel for cryopreservation by vitrification in a liquid cryogen of claim 1, further comprising a lid over the openings of said recesses, the lid able to be opened and closed.

8. A kit comprising:
a vessel for cryopreservation by vitrification in a liquid cryogen which functions in the cryopreservation of cells or embryos contained in vitrification solution, the vessel including:
a retaining part configured to retain cells or embryos,
wherein said retaining part possesses one or more recesses configured to receive the cells or the embryos therein, and
one or more walls constituting said recesses possess one or more holes which do not allow the cells or the embryos to pass therethrough, but allow vitrification solution to pass therethrough; and
a tube for storing at least the retaining part which retains the cells or the embryos on said vessel for cryopreservation by vitrification in a liquid cryogen.

9. The kit of claim 8, wherein said tube is in a sealed condition and an inside of said tube is sterilized, and said tube is configured to insertably receive said vessel from a tip of said retaining part by opening one side of said tube and then is sealed at a prescribed position where said retaining part has passed through an entrance of said tube after inserting said vessel retaining the cells or the embryos to said retaining part into said tube.

10. The kit of claim 9, wherein said vessel comprises a grip on one end of the vessel and said tube is sealable at said prescribed position along a length of said grip after inserting said vessel into said tube.

11. The kit of claim 9, wherein said vessel comprises a diameter expansion component having a larger diameter than a diameter of said retaining part, the diameter expansion component being positioned between said retaining part and said one end and said tube is sealable at said prescribed position on said diameter expansion component after inserting said vessel into said tube.

12. The kit of claim 9, wherein said tube displays a position for opening the tube.

13. A method for the cryopreservation of cells or embryos by vitrification in a liquid cryogen comprising:
providing a vessel including:
a retaining part configured to retain cells or embryos,
wherein said retaining part possesses one or more recesses configured to receive the cells or the embryos therein, and
one or more walls constituting said recesses possess one or more holes which do not allow the cells or the embryos to pass therethrough, but allow vitrification solution to pass therethrough; and
placing said cells or embryos in the recesses of the vessel for cryopreservation by vitrification in a liquid cryogen.

14. The method for cryopreservation of cells or embryos by vitrification in a liquid cryogen of claim 13 further comprising:
inserting said vessel into said vitrification solution containing said cells or embryos, and placing said cells or embryos into the recesses of said vessel in said vitrification solution.

15. The method for the cryopreservation of cells or embryos by vitrification in a liquid cryogen of claim 13 further comprising:
taking said vessel for cryopreservation by vitrification in a liquid cryogen retaining said cells or embryos in said recesses out of said vitrification solution, and directly immersing said vessel in a cryogen or inserting an end of said vessel into a tube that is immersed in a cryogen.

16. The method for the cryopreservation of cells or embryos by vitrification in a liquid cryogen of claim 15 further comprising:
directly immersing said vessel in the cryogen or inserting the end of said vessel into the tube within 1 to 90 seconds after taking said vessel out of said vitrification solution.

17. The method for the cryopreservation of cells or embryos by vitrification in a liquid cryogen of claim 13 further comprising:
placing at least three wells on the internal bottom surface of a dish, the wells having an equal or lower height as an internal depth of the dish;
putting equilibrium solution into one or more first wells, putting vitrification solution into one or more second and third wells, and immersing said recesses of said vessel in vitrification solution in advance;
transferring the cells or the embryos from the first wells to the second wells and then to the third wells;
lifting said vessel containing said cells or embryos in the recesses out of the vitrification solution in the third wells; and
immersing said vessel with said cells or embryos in a cryogen.
